(19) United States
(12) Patent Application Publication
(10) Pub. No.: US 2026/0329985 A1
(43) Pub. Date: Oct. 22, 2026

(54) SYSTEMS AND METHODS FOR AUTHENTICATING DATA ACCESS USING CONTEXT-AWARE MULTI-DIMENSIONAL PRIVACY AND ACCESS TOKENS

(71) Applicant: Verizon Patent and Licensing Inc., Basking Ridge, NJ (US)

(72) Inventors: Raghuram PARVATANENI, Frisco, TX (US); Parry Cornell BOOKER, Sunnyvale, TX (US); Manian KRISHNAMOORTHY, Derry, NH (US)

(73) Assignee: Verizon Patent and Licensing Inc., Basking Ridge, NJ (US)

(21) Appl. No.: 19/185,736

(22) Filed: Apr. 22, 2025

(51) Int. Cl. G06F 21/31

(52) U.S. Cl. CPC G06F 21/31

(57) ABSTRACT

A device may receive, from a user device, a request for authentication of a user of the user device to access data, and may receive, based on the request for authentication, contextual data identifying contextual parameters associated with the user device, the user, one or more risk factors, and one or more policy rules. The device may aggregate the contextual data to generate aggregated contextual data, and may generate a multi-dimensional privacy and access token (MuDAT) that encodes the aggregated contextual data. The device may calculate a trust rating for the MuDAT based on the contextual data, and may provide the MuDAT to the user device. The device may utilize the MuDAT and the trust rating to validate data requests received from the user device.

### BACKGROUND

In telecommunications networks and application programming interface (API) ecosystems, access control plays a critical role in ensuring the security and appropriate use of sensitive data.

### BRIEF DESCRIPTION OF THE DRAWINGS

FIGS. 1A-1H are diagrams of an example associated with authenticating data access using context-aware multi-dimensional privacy and access tokens.

FIG. 2 is a diagram of an example environment in which systems and/or methods described herein may be implemented.

FIG. 3 is a diagram of example components of one or more devices of FIG. 2.

FIG. 4 is a flowchart of an example process for authenticating data access using context-aware multi-dimensional privacy and access tokens.

### DETAILED DESCRIPTION OF EXAMPLE EMBODIMENTS

The following detailed description of example implementations refers to the accompanying drawings. The same reference numbers in different drawings may identify the same or similar elements.

Traditional API gateways, such as Apigee, Kong, or in-house solutions, typically enforce access based on static or role-based policy checks. An API request is authorized or denied based on a user's identity, assigned scope, and other pre-configured rules. These measures are foundational for authentication and authorization processes. However, such measures fail to adapt to the dynamic nature of real-world interactions and fail to consider variables that change rapidly, such as a current location of a user, a security status of a user device used by the user, the presence of suspicious activity, and variations in network conditions. These static approaches to access control can lead to significant security and operational challenges. For example, when dealing with sensitive data (e.g., user location data, know your customer (KYC) data, account and billing data, or device status data), a purely static policy can result in either too much data exposure (e.g., leading to potential data breaches) or too little data being made available (e.g., resulting in operational inefficiencies). This can increase the risk of data leaks or impede the functionality of systems that require timely and context-appropriate data access. Moreover, the static systems are unable to incorporate real-time network conditions or adapt to user subscription levels, adding further limitations to the efficacy of the static systems. Thus, the static systems risk data privacy and security and also potentially restrict the flow of necessary information.

Thus, current techniques for handling sensitive data consume computing resources (e.g., processing resources, memory resources, communication resources, and/or the like), networking resources, and/or other resources associated with handling data breaches caused by too much data exposure, handling operational inefficiencies caused by too little data being made available, failing to provide timely and context-appropriate data access, causing data leaks due to failing to provide timely and context-appropriate data access, impeding the functionality of systems due to failing to provide timely and context-appropriate data access, and/or the like.

Some implementations described herein provide a security system that authenticates data access using context-aware multi-dimensional privacy and access tokens. For example, the security system may receive, from a user device, a request for authentication of a user of the user device to access data, and may receive, based on the request for authentication, contextual data identifying contextual parameters associated with the user device, the user, one or more risk factors, and one or more policy rules. The security system may aggregate the contextual data to generate aggregated contextual data, and may generate a multi-dimensional privacy and access token (MuDAT) that encodes the aggregated contextual data. The security system may calculate a trust rating for the MuDAT based on the contextual data, and may provide the MuDAT to the user device. The security system may utilize the MuDAT and the trust rating to validate data requests received from the user device.

In this way, the security system authenticates data access using context-aware multi-dimensional privacy and access tokens. For example, the security system may receive a request for user authentication from a user of a user device, may gather contextual data related to the user and the user device, and may aggregate the contextual data to create a MuDAT. The security system may calculate a trust rating for the MuDAT based on the contextual data and may provide the MuDAT to the user device. The security system may continually monitor the contextual data, and may update the MuDAT and the trust rating in real-time based on any modifications to the contextual data. Furthermore, the security system may determine the validity of the MuDAT when a data access request is received, and may deny access or partially mask the data if the trust rating fails to satisfy a required threshold. Thus, the security system may dynamically adjust access rights using multi-factor analysis of real-time contextual data. By incorporating multiple contextual factors into the MuDAT, the security system may ensure that access control decisions are made with an accurate representation of the current environment, enhancing data security and reducing potential malicious attacks.

Thus, the security system may conserve computing resources, networking resources, and/or other resources that would have otherwise been consumed by handling data breaches caused by too much data exposure, handling operational inefficiencies caused by too little data being made available, failing to provide timely and context-appropriate data access, causing data leaks due to failing to provide timely and context-appropriate data access, impeding the functionality of systems due to failing to provide timely and context-appropriate data access, and/or the like.

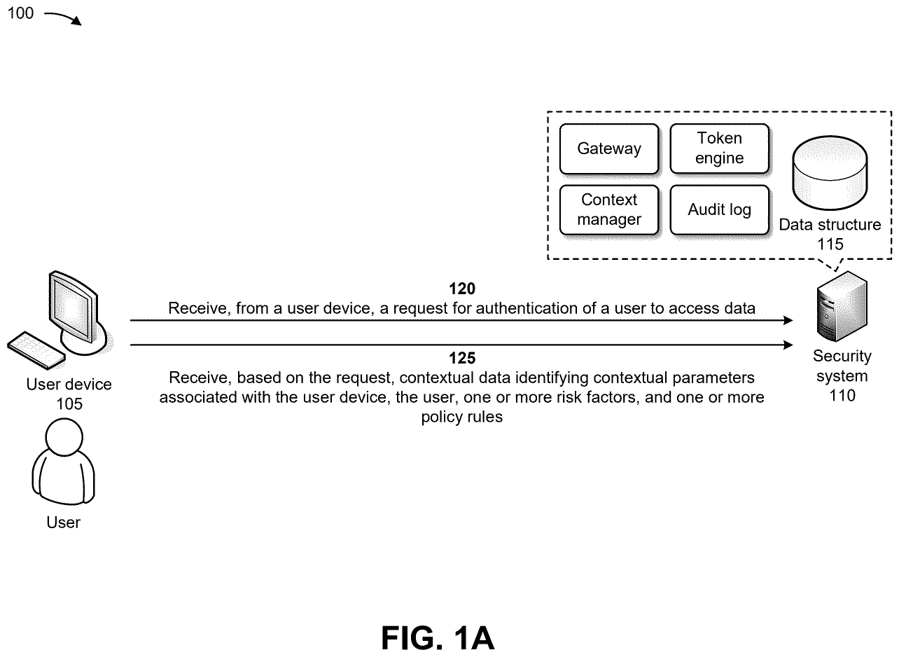

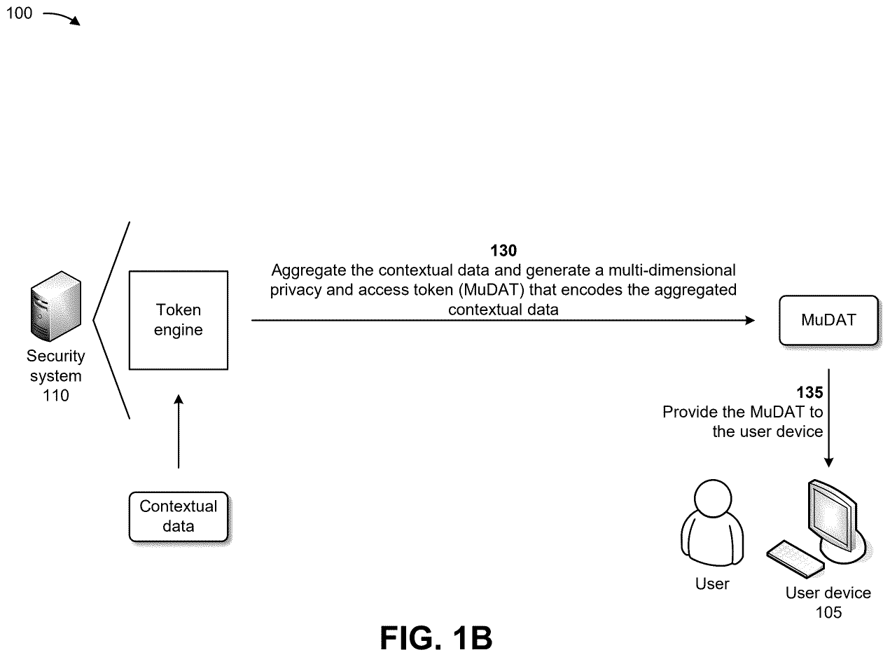

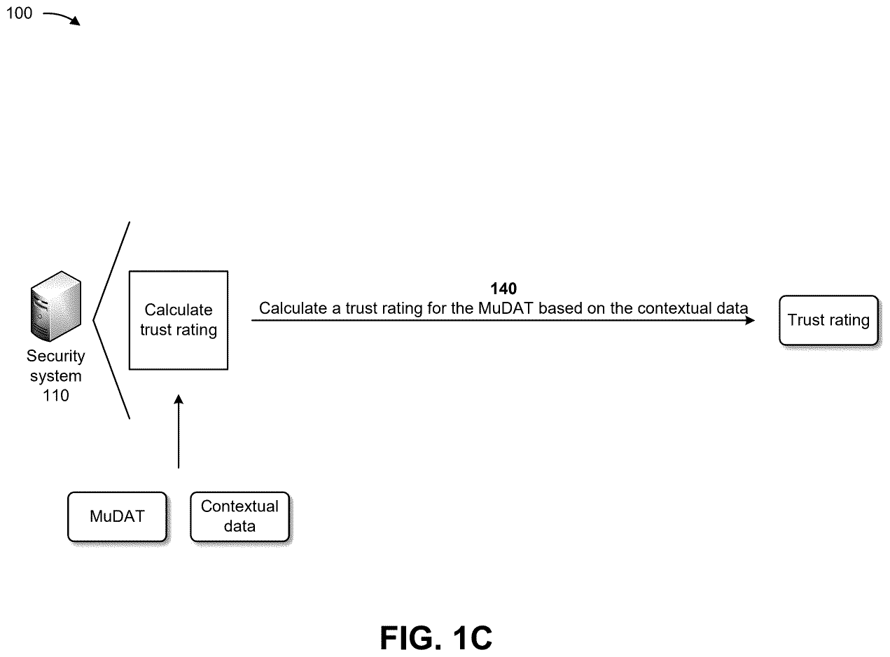

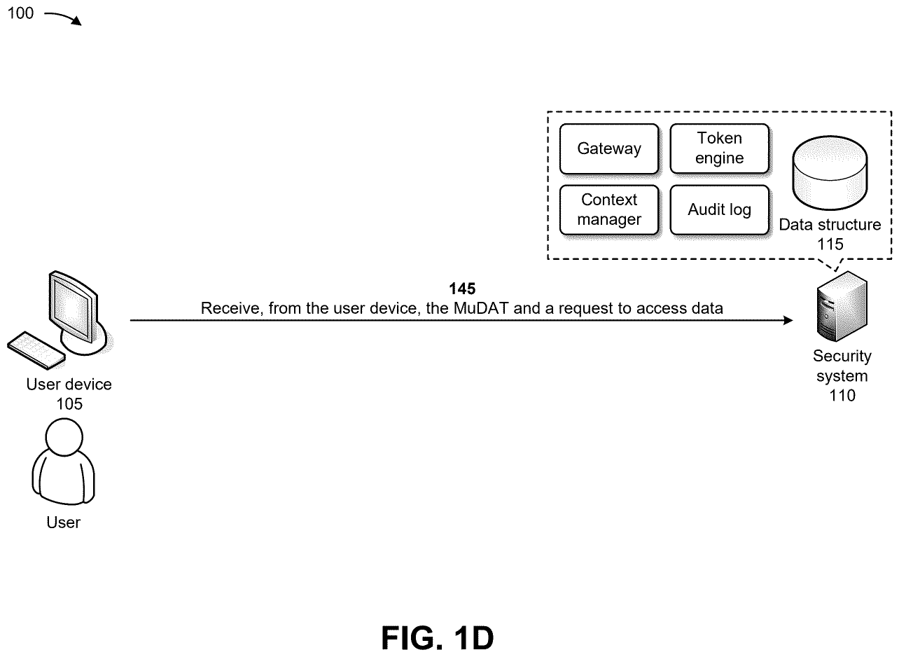

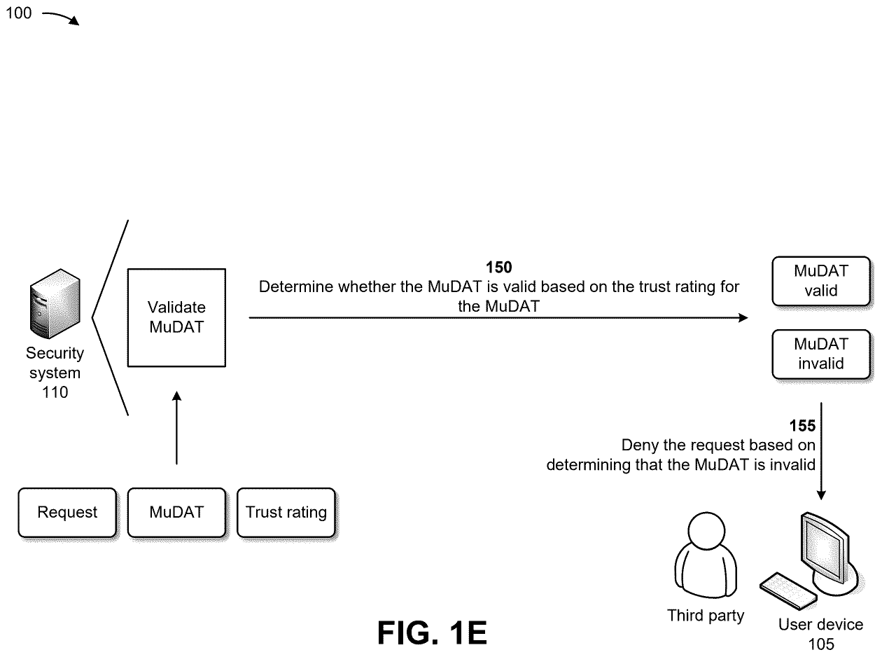

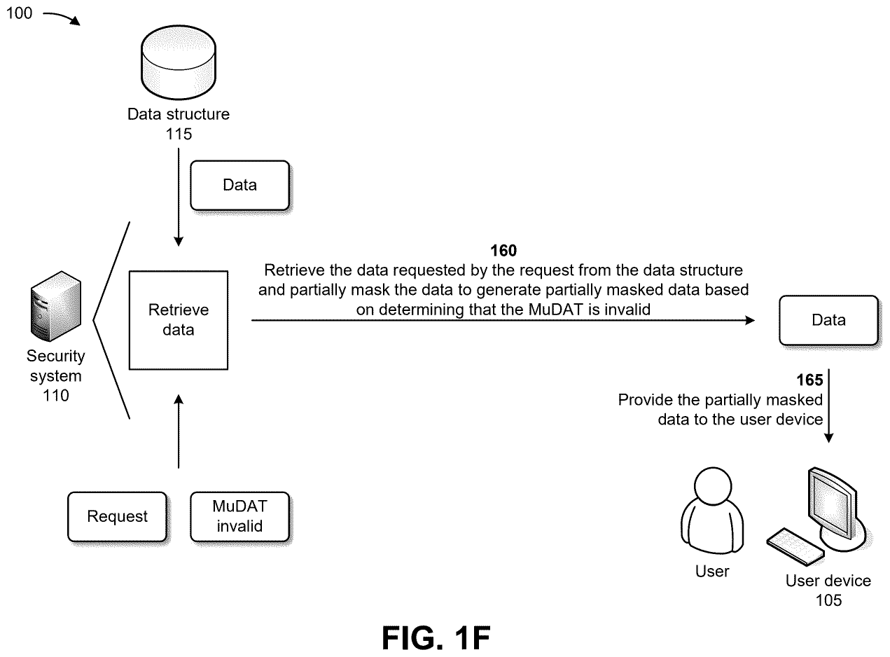

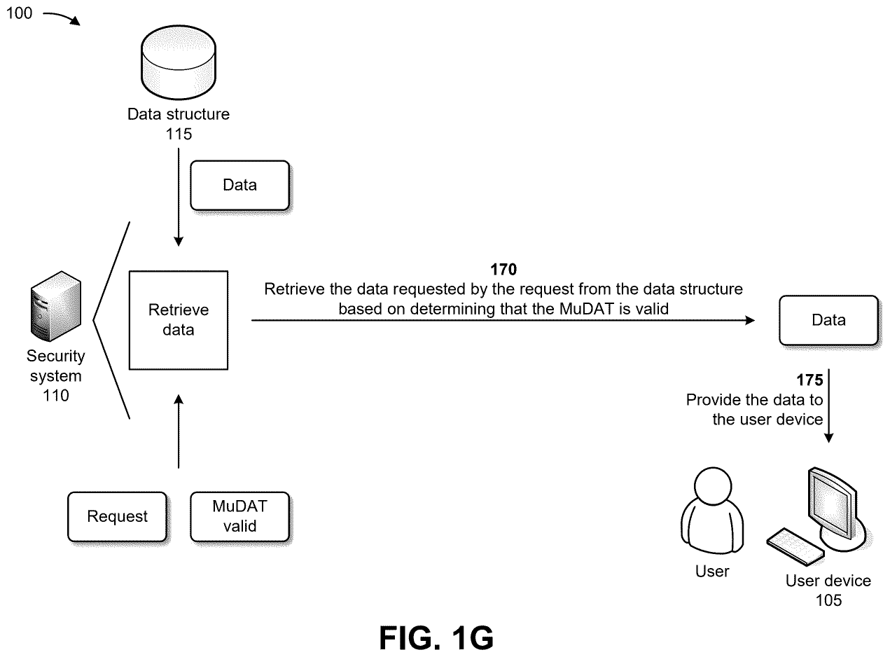

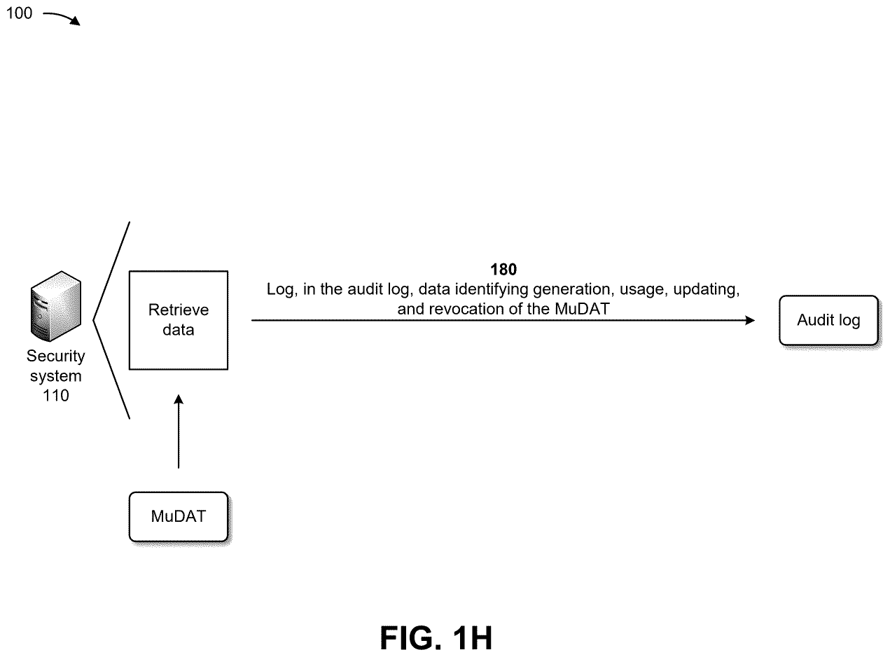

FIGS. 1A-1H are diagrams of an example 100 associated with authenticating data access using context-aware multi-dimensional privacy and access tokens. As shown in FIGS. 1A-1H, the example 100 includes a user device 105 associated with a user, a security system 110, and a data structure 115. The user may utilize the user device 105 to interact with the security system 110 and/or the data structure 115. The security system 110 may include a system that authenticates data access using context-aware multi-dimensional privacy and access tokens. The data structure 115 may include a database, a table, a list, and/or the like that stores information. Further details of the user device 105, the security system 110, and the data structure 115 are provided elsewhere herein. Although implementations described herein depict a single user device 105 and a single data structure 115, in some implementations, the security system 110 may be associated with multiple user devices 105 and/or multiple data structures 115.

As shown in FIG. 1A, the security system 110 may include a gateway, a token engine, a context manager, an audit log, and the data structure 115. The gateway may include a network device (e.g., a router, a gateway, a switch, a firewall, a hub, a bridge, a reverse proxy, a server (e.g., a proxy server, a cloud server, or a data center server), a load balancer, and/or a similar device. The gateway may receive data requests and MuDATs from users and may determine whether the MuDATs satisfy thresholds for data requested in the data requests. In some implementations, the gateway may receive data requests or queries (e.g., via an application programming interface (API)) and MuDATs from users and may determine whether the data requests or queries and/or data usage are valid based on whether the multi-dimensional privacy and access tokens satisfy the thresholds. For example, the gateway may determine whether a trust rating for the MuDAT satisfies (e.g., meets or exceeds) thresholds for the data requested via the API.

The token engine may receive contextual data identifying a location (e.g., a home country, a foreign country, an authorized geo-zone, and/or the like) of the user and/or the user device 105, a posture of the user device 105 (e.g., an operating system patch level, whether the user device is recognized or unknown, whether a secure environment is available, and/or the like), a time window (e.g., regular business hours, after business hours, and/or the like), a subscription level of the user (e.g., a premium user or a standard user), network conditions for the user device 105 (e.g., congested cell tower or normal load), a risk profile of the user (e.g., suspicious user behavior, a blacklisted region, and/or the like), and/or the like. The token engine may generate a MuDAT that dynamically encodes the contextual data into a trust rating. The token engine may issue a MuDAT that reflects a real-time context of a data request, and may ensure that each API invocation is granted only an appropriate level of data access. Each dimension of the contextual data may contribute to the trust rating (e.g., a multi-dimensional vector) of the MuDAT. If any dimension changes or the trust rating drops below a threshold, the security system 110 may automatically adjust or revoke data access. In some implementations, the token engine may continually receive and evaluate the contextual data. If the contextual data changes in the middle of a session (e.g., when the user device 105 transitions from Wi-Fi to roaming), the token engine may update the MuDAT or invalidate the MuDAT in real-time. In some implementations, the token engine may validate user authentication requests, may aggregate the contextual data, and may generate MuDATs based on the aggregated contextual data and including relevant context signatures or a trust score.

The context manager may retrieve real-time contextual data associated with user devices 105 associated with users. The contextual data may include device information of the user devices, subscription levels of the users, locations of the users and/or the user devices 105, time-of-day, risk signals associated with the user devices 105, network load associated with a network of the user devices 105, and/or the like. In some implementations, the context manager may detect changes to contextual data associated with a user device 105 (e.g., the user device 105 has been jailbroken). Based on the changes to the contextual data, the context manager may revoke or update a MuDAT associated with the user device 105, forcing the user device 105 to request a new MuDAT. Thus, the context manager may prevent “token replay” attacks where an old token is used in a new, riskier context. In some implementations, the context manager may aggregate the contextual data (e.g., real-time user device data, user attributes, environmental data, and/or the like).

The audit log may include data generated during retrieval of the data and validation of a MuDAT. The data may include an identity of who or what generated a data request, a timestamp of the request, input parameters provided in the request, policy references, data usage, or a result or type of output produced. The audit log may be stored in a secure audit system (e.g., immutably on a distributed ledger or via a secure logging service). In some implementations, the security system 110 may log, in the audit log, data identifying generation, usage, updating, and revocation of a MuDAT. The audit log may capture data request inputs (e.g., metadata) and outputs (e.g., metadata, not raw data). A security information and event management (SIEM) system or a blockchain-based ledger may be utilized to ensure that the audit log is tamperproof. In some implementations, the audit log may include a log for every query execution, to ensure compliance and accountability.

The data structure 115 may store sensitive data, such as customer data from a telecommunications provider, private data from agencies, and/or the like. The data structure 115 may store data in an encrypted format, such as a homomorphic encryption (HE) format (e.g., a form of encryption that allows computations to be carried out on ciphertext, generating an encrypted result that, when decrypted, matches the result of operations performed on the plaintext and enables secure data processing without exposing the underlying data), a functional encryption format (e.g., a cryptographic approach that allows decrypting only specific “functions” of the data rather than full plain text), and/or the like. In some implementations, the data structure 115 may receive sensitive customer data from the telecommunications provider and private data from users. The data structure 115 may encrypt the data with a key management service. All keys may remain under enterprise control, and users never handle keys that can directly decrypt the data. The data structure 115 may anonymize or tokenize sensitive fields of the stored data before providing the stored data to the secure platform. This may mitigate security risks in case of accidental leakage of data outside the secure platform. In some implementations, the data structure 115 may utilize zero knowledge proofs (ZKPs) for certain scenarios to verify statements about data without revealing the data). For example, a user may prove that the user is located in a certain region without revealing the user's exact location. For analytics use cases (e.g., aggregated queries), the data structure 115 may apply differential privacy noise so that results do not reveal details of individuals in the dataset. The data structure 115 may provide, to the secure platform, only the encrypted data necessary for execution of a function or calculation of analytics.

In some implementations, the data structure 115 may provide advanced data management. For example, the data structure 115 may provide a Redis cache for sub-millisecond fraud pattern matching, a time series database for pattern analysis and anomaly detection, a graph database for relationship analysis and fraud ring detection, and a key-value store for rapid customer profile lookup. Alternatively, or additionally, the data structure 115 may provide a smart caching strategy. For example, the data structure may provide a hot cache (e.g., a last twenty-four hours of fraud patterns), a warm cache (e.g., thirty days of customer behavior profiles), and a cold storage (e.g., historical data for training and analysis).

As further shown in FIG. 1A, and by reference number 120, the security system 110 may receive, from the user device 105, a request for authentication of a user to access data. For example, the user may cause the user device 105 to generate the request for authentication of the user to access data from the security system 110. The user device 105 may provide the request for authentication to the security system 110, and the security system 110 may receive the request for authentication. The request for authentication may include credentials of the user (e.g., a username, a password, a passcode, and/or the like) and other relevant information necessary for the authenticating the user, such as login details of the user, biometric data of the user, security questions to validate an identity of the user, or multi-factor authentication steps (e.g., sending a verification code to the user device 105 or the user's email address). In some implementations, the security system 110 may check the user's credentials against a database of known users and may verify the accuracy and validity of the information in the request for authentication.

As further shown in FIG. 1A, and by reference number 125, the security system 110 may receive, based on the request for authentication, contextual data identifying contextual parameters associated with the user device, the user, one or more risk factors, one or more policy rules, and/or the like. For example, based on receiving the request for authentication, the security system 110 may retrieve contextual data, such as a current location of the user device 105 (e.g., via global position system (GPS) data), a security status of the user device 105 (e.g., whether the user device 105 is jailbroken or has an outdated operating system), a time of the request for authentication, the user's subscription level, network conditions associated with the user device 105 (e.g., monitoring network traffic for suspicious patterns), any detected suspicious activity of the user device 105, policy compliance, recent activity of the user device 105, and/or the like. The contextual data may enable the security system 110 to provide a dynamic and nuanced approach to authentication, and to enhance security by considering real-time factors that impact a validity and appropriateness of a data access request. In some implementations, the security system 110 may continually receive the contextual data, may periodically receive the contextual data, may receive the contextual data based on receiving the request for authentication, may receive the contextual data based on requesting the contextual data from the user device 105 and other network systems associated with the user device 105, and/or the like.

As shown in FIG. 1B, and by reference number 130, the security system 110 may aggregate the contextual data to generate aggregated contextual data, and may generate a MuDAT that encodes the aggregated contextual data. For example, the security system 110 may aggregate the contextual data to form the aggregated contextual data by assigning weights to the various context parameters or dimensions of the contextual data and combining the weighted context parameters to form the aggregated contextual data. In one example, the security system 110 may assign a first weight (e.g., a 25% weight) to location context, a second weight (e.g., a 20% weight) to user device context, a third weight (e.g., a 15% weight) to temporal context, a fourth weight (e.g., a 20% weight) to network context, a fifth weight (e.g., a 20% weight) to risk context, and/or the like. The security system 110 may then combine the weighted contexts together to generate the aggregated contextual data. The security system 110 may also utilize per-dimension factors to generate the aggregated contextual data, such as multiple evaluation criteria, a weighted scoring system, a dynamic threshold adjustment, and/or the like.

The security system 110 may then encode the aggregated contextual data to generate the MuDAT. The encoding process may include the security system 110 creating a structured token that includes multiple dimensions of the contextual data. Each dimension may represent a specific type of contextual data, such as location, user device security status, user subscription level, network conditions, and/or the like. The MuDAT may be dynamic, meaning that the MuDAT may be updated by the security system 110 in real-time based on changes in the contextual data. If any dimension of the contextual data changes (e.g., the user device 105 moves to a different location or the network conditions change), the security system 110 may update the MuDAT accordingly. By encoding the aggregated contextual data into the MuDAT, the security system 110 may ensure that access control decisions are made based on a comprehensive and real-time assessment of the user's context. This may enhance data security and may reduce the risk of unauthorized access or data breaches. In some implementations, the security system 110 may digitally sign the MuDAT to generate an encrypted MuDAT and prevent tampering. For example, the encrypted MuDAT may include hashed dimension values or short claims (e.g., location=allowed, device=trusted, time=valid, or risk=low).

As further shown in FIG. 1B, and by reference number 135, the security system 110 may provide the MuDAT to the user device 105. For example, after the MuDAT is generated, the security system 110 may provide the MuDAT to the user device 105. The user device 105 may receive the MuDAT, and may utilize the MuDAT to request access to data from the security system 110 or other connected systems. The MuDAT may serve as a dynamic access token that reflects the real-time context of the user and the user device 105, thereby enabling more secure and context-aware data access. In some implementations, if the contextual data is modified, the security system 110 may aggregate the modified contextual data, and may generate an updated MuDAT that encodes the aggregated modified contextual data. The security system 110 may provide the updated MuDAT to the user device 105, and the user device 105 may replace the MuDAT with the updated MuDAT.

As shown in FIG. 1C, and by reference number 140, the security system 110 may calculate a trust rating for the MuDAT based on the contextual data. For example, the security system 110 may evaluate various contextual parameters associated with the user device 105, the user, one or more risk factors, one or more policy rules, and/or the like. The contextual parameters may include location data, user device security status, user subscription level, network conditions, time-specific data, risk profiles, and/or the like. The security system 110 may calculate the trust rating by assigning weights to each contextual parameter based on their relevance and impact on security. For example, location data may be assigned a higher weight if accessing data from certain regions poses higher risks. The security system 110 may then combine these weighted contextual parameters to derive an overall trust rating. The trust rating may provide a real-time context of the user and the user device 105, enabling the security system 110 to make informed decisions regarding data access requests received from the user and the user device 105. In one example, if the contextual data indicates that the user device 105 is operating from a secure location, has an up-to-date operating system, and exhibits no suspicious behavior, the trust rating may be high, allowing broader data access. Conversely, if the user device 105 is detected in a high-risk region or has outdated security patches, the trust rating may be lower, leading to restricted data access or denial of requests. Additionally, or alternatively, the trust rating may be visually represented using a trust score meter within a user interface generated by the security system. The visual representation may provide a clear and intuitive understanding of the trust rating.

In some implementations, the security system 110 may dynamically update the trust rating based on continually assessing the contextual parameters associated with the user device 105 and the user. As the contextual parameters change, the security system 110 may adjust the trust rating in real-time to reflect a current security context. Additionally, or alternatively, the security system 110 may utilize a machine learning model to predict the trust rating based on historical and real-time contextual data. The machine learning model may analyze patterns in the contextual data to generate more accurate trust ratings.

Additionally, or alternatively, the security system 110 may calculate the trust rating based on a frequency and a pattern of data access requests made by the user device 105. Frequent or unusual access patterns may influence the trust rating, potentially identifying suspicious behavior. Additionally, or alternatively, the security system 110 may calculate the trust rating based on additional contextual factors such as user behavior analytics and threat intelligence data. These additional factors may provide a more comprehensive view of the security landscape and contribute to a more precise trust rating. Additionally, or alternatively, the security system 110 may calculate the trust rating based on compliance requirements specific to the data being accessed by the user device 105. Compliance with regulatory standards may positively impact the trust rating by ensuring that data access adheres to legal and security requirements.

Additionally, or alternatively, the security system 110 may periodically recalibrate the weights assigned to each contextual parameter to reflect changes in the security landscape, and may recalculate the trust rating based on the recalibrated weights. The recalibration may ensure that the trust rating remains accurate and relevant over time. Additionally, or alternatively, the security system 110 may enforce different data access policies based on the trust rating, such as requiring multi-factor authentication for low trust ratings. This enforcement may enhance security by adapting the access controls to the trust rating.

As shown in FIG. 1D, and by reference number 145, the security system 110 may receive, from the user device 105, the MuDAT and a request to access data. For example, the user may cause the user device 105 to generate the request to access data. The user device 105 may provide the MuDAT and the request to access data to the security system 110. The MuDAT may include contextual data identifying contextual parameters associated with the user device 105, the user, one or more risk factors, one or more policy rules, and/or the like. The request to access data may specify the data that the user of the user device 105 wishes to access. The security system 110 may receive the MuDAT and the request to access data, and may proceed to validate the MuDAT based on the contextual data and the trust rating associated with the MuDAT before providing access to the data, as described below.

In one example, the request to access data may include a location retrieval API request with high-level location data (e.g., which may require a moderate trust rating, such as a secure user device and a local user), precise GPS data (e.g., which may require a higher trust rating, such as a recognized user device with the user's explicit consent within a specific time window), and/or the like. In another example, the request to access data may include a KYC fill-in API request or a KYC match API request. In such an example, if the user device 105 is unpatched or flagged as risky, the trust rating may be too low to reveal personal data, so only partial, masked information may be provided. If the user device 105 is secure, a user subscription is premium, and a location is consistent with user records, the trust rating may be high enough to release additional KYC fields. In still another example, the request to access data may include a SIM swap API request. In such an example, a telecommunications provider may demand a high trust rating, ensuring that the request is truly from an intended financial institution. If the user's location or the user device 105 is suspicious (e.g., a request coming from an overseas network address never before used), the trust rating may be insufficient for a full SIM swap check. In another example, the request to access data may include a carrier billing/refund API request. In such an example, for small transactions, a lower trust rating may suffice. For high-value refunds, a higher trust rating or a multi-factor check may be triggered.

As shown in FIG. 1E, and by reference number 150, the security system 110 may determine whether the MuDAT is valid based on the trust rating for the MuDAT. For example, the security system 110 may evaluate the trust rating associated with the MuDAT to determine whether the trust rating satisfies a threshold trust rating for accessing the requested data. If the trust rating satisfies the required thresholds, the security system 110 may determine that the MuDAT is valid. Conversely, if the trust rating fails to satisfy the required thresholds, the security system 110 may determine that the MuDAT is invalid. In some implementations, the thresholds may be associated with various levels of data sensitivity. Additionally, or alternatively, the security system 110 may dynamically adjust the thresholds based on real-time contextual data changes.

As further shown in FIG. 1E, and by reference number 155, the security system 110 may deny the request based on determining that the MuDAT is invalid. For example, if the MuDAT is determined to be invalid due to an insufficient trust rating, the security system 110 may deny the data access request. The security system 110 may generate a notification indicating that the request to access data has been denied due to the invalid MuDAT, and may provide the notification to the user device 105. By denying the request, the security system 110 may prevent access to sensitive data and may ensure that security protocols are upheld. In some implementations, the security system 110 may log the rejection event for auditing purposes in the audit log. Additionally, or alternatively, after denying the request, the security system 110 may prompt the user to re-authenticate or provide additional verification information for the request to access data.

As shown in FIG. 1F, and by reference number 160, the security system 110 may retrieve the data requested by the request from the data structure 115 and may partially mask the data to generate partially masked data based on determining that the MuDAT is invalid. For example, the security system 110 may evaluate the trust rating associated with the MuDAT and may determine that the MuDAT is invalid due to an insufficient trust rating (e.g., a trust rating that fails to satisfy one or more thresholds). Upon this determination, the security system 110 may access the data structure 115 to retrieve the requested data and may apply masking techniques to redact sensitive portions (e.g., data fields) of the data and to generate the partially masked data. The partial masking of the data may ensure that even if the MuDAT is inappropriate for full data access, the user device 105 does not receive any highly sensitive information that could lead to data breaches or security vulnerabilities. The masking may include techniques such as anonymization, tokenization, encryption of specific data fields, and/or the like.

As further shown in FIG. 1F, and by reference number 165, the security system 110 may provide the partially masked data to the user device 105. For example, after generating the partially masked data, the security system 110 may provide the partially masked data to the user device 105. The user device 105 may receive the partially masked data and present the partially masked data to the user in a format that prevents the exposure of sensitive information while still providing enough data to fulfill the request to access data in a secure manner. This may ensure that the security system 110 maintains data security and compliance with privacy regulations, even when the MuDAT fails to meet the required trust rating for full data access.

As shown in FIG. 1G, and by reference number 170, the security system 110 may retrieve the data requested by the request from the data structure 115 based on determining that the MuDAT is valid. For example, the security system 110 may evaluate the trust rating associated with the MuDAT and may determine that the trust rating satisfies a required threshold for accessing the requested data. Upon this determination, the security system 110 may access the data structure 115 to retrieve the data specified in the request to access data. This may ensure that only valid MuDATs, which reflect the real-time context of the user and the user device 105, are granted access to the sensitive data stored in the data structure 115.

As further shown in FIG. 1G, and by reference number 175, the security system 110 may provide the data to the user device 105. For example, after retrieving the requested data from the data structure 115, the security system 110 may provide the data to the user device 105. The user device 105 may receive the data and may present the data to the user, ensuring secure and context-aware access to the sensitive data. In some implementations, the security system 110 may encrypt the data to generate encrypted data, and may provide the encrypted data to the user device 105. This may ensure that the data is not hijacked during transmission to the user device 105. Additionally, or alternatively, the security system 110 may securely transmit the data to the user device 105 to maintain data integrity and security. For example, the security system 110 may utilize secure transmission protocols when providing the data to the user device 105 to ensure that the data remains unaltered during transit.

As shown in FIG. 1H, and by reference number 180, the security system 110 may log, in the audit log, data identifying generation, usage, updating, and revocation of the MuDAT. For example, the security system 110 may track and record data about each MuDAT, including when the MuDAT was generated, how the MuDAT has been used, any updates or modifications made to the MuDAT, and any instances where the MuDAT was revoked. The recorded data may include details such as timestamps, user identity, contextual parameters, and reasons for any changes or revocations. The security system 110 may store the recorded data in the audit log. This may ensure that a comprehensive and auditable record of the MuDAT is maintained, and may enhance the ability to monitor and enforce compliance with security and privacy policies. The audit log may be stored securely and may be used for regulatory compliance, troubleshooting, and forensic analysis to understand the context in which data access decisions are made. In some implementations, the security system 110 may log, in the audit lot, each action taken with respect to a MuDAT and with precise details to ensure that every step in the MuDAT lifecycle is documented.

In some implementations, the security system 110 may assign each data field a minimum trust level that is stored in a dynamic policy database. This may enable fine-grained control over data exposure based on the current contextual conditions. The policies may be easily updated to adapt to changing security requirements or regulatory standards, ensuring that data access is always granted appropriately. In some implementations, the security system 110 may utilize a smart caching strategy, which includes predictive token pre-generation and context-aware cache invalidation. A distributed cache with consistency guarantees may ensure that the security system 110 can efficiently handle high volumes of data access requests while maintaining up-to-date and relevant contextual data. The security system 110 may implement advanced cryptographic techniques, such as elliptic curve cryptography for token signing and zero-knowledge proofs for sensitive attributes. Homomorphic encryption may be used for trust calculations, enabling secure data processing without exposing the underlying data, further enhancing the security and privacy of the security system 110.

In this way, the security system 110 authenticates data access using context-aware multi-dimensional privacy and access tokens. For example, the security system 110 may receive a request for user authentication from a user of a user device 105, may gather contextual data related to the user and the user device 105, and may aggregate the contextual data to create a MuDAT. The security system 110 may calculate a trust rating for the MuDAT based on the contextual data and may provide the MuDAT to the user device 105. The security system 110 may continually monitor the contextual data, and may update the MuDAT and the trust rating in real-time based on any modifications to the contextual data. Furthermore, the security system 110 may determine the validity of the MuDAT when a data access request is received, and may deny access or partially mask the data if the trust rating fails to satisfy a required threshold. Thus, the security system 110 may dynamically adjust access rights using multi-factor analysis of real-time contextual data. By incorporating multiple contextual factors into the MuDAT, the security system may ensure that access control decisions are made with an accurate representation of the current environment, enhancing data security and reducing potential malicious attacks.

Thus, the security system 110 may conserve computing resources, networking resources, and/or other resources that would have otherwise been consumed by handling data breaches caused by too much data exposure, handling operational inefficiencies caused by too little data being made available, failing to provide timely and context-appropriate data access, causing data leaks due to failing to provide timely and context-appropriate data access, impeding the functionality of systems due to failing to provide timely and context-appropriate data access, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

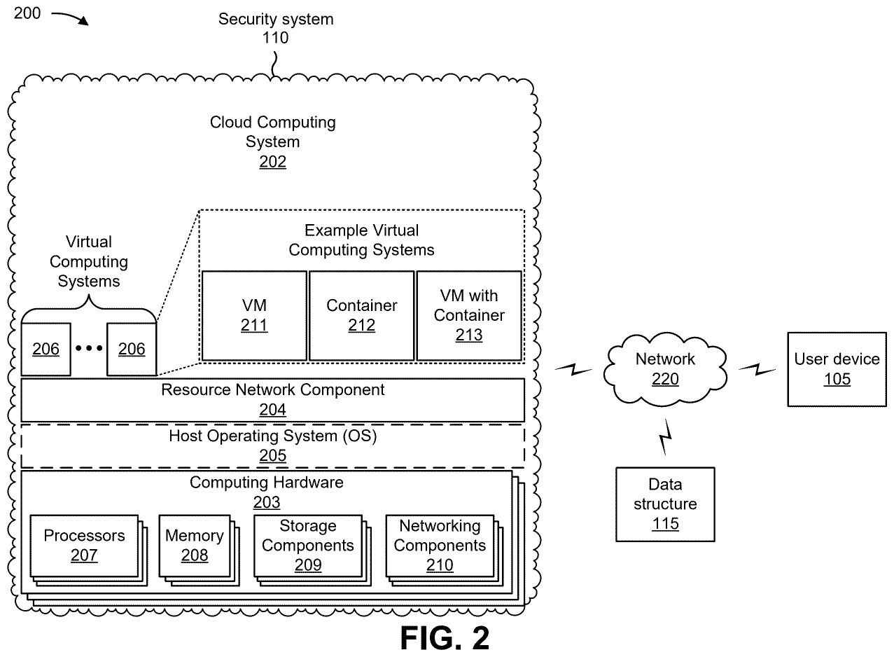

FIG. 2 is a diagram of an example environment 200 in which systems and/or methods described herein may be implemented. As shown in FIG. 2, the environment 200 may include the security system 110, which may include one or more elements of and/or may execute within a cloud computing system 202. The cloud computing system 202 may include one or more elements 203-213, as described in more detail below. As further shown in FIG. 2, the environment 200 may include the user device 105, the data structure 115, and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The data structure 115 may include one or more devices capable of receiving, generating, storing, processing, and/or providing information, as described elsewhere herein. The data structure 115 may include a communication device and/or a computing device. For example, the data structure 115 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 115 may communicate with one or more other devices of the environment 200, as described elsewhere herein.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

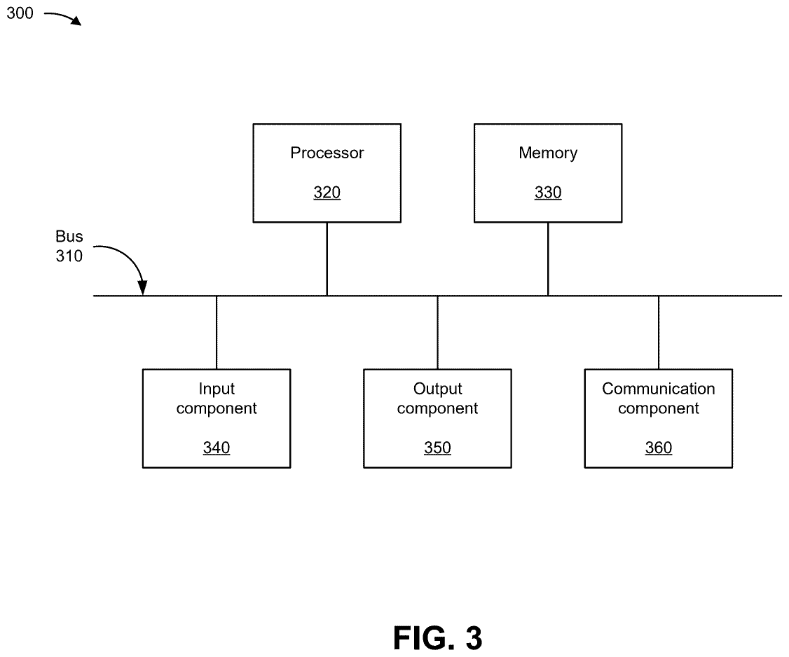

Although the security system 110 may include one or more elements 203-213 of the cloud computing system 202, may execute within the cloud computing system 202, and/or may be hosted within the cloud computing system 202, in some implementations, the security system 110 may not be cloud-based (e.g., may be implemented outside of a cloud computing system) or may be partially cloud-based. For example, the security system 110 may include one or more devices that are not part of the cloud computing system 202, such as a device 300 of FIG. 3, which may include a standalone server or another type of computing device. The security system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200. In some implementations, the network 220 includes a network capable of providing network slices, such as a 5G core network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the security system 110, and/or the data structure 115. In some implementations, the user device 105, the security system 110, and/or the data structure 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

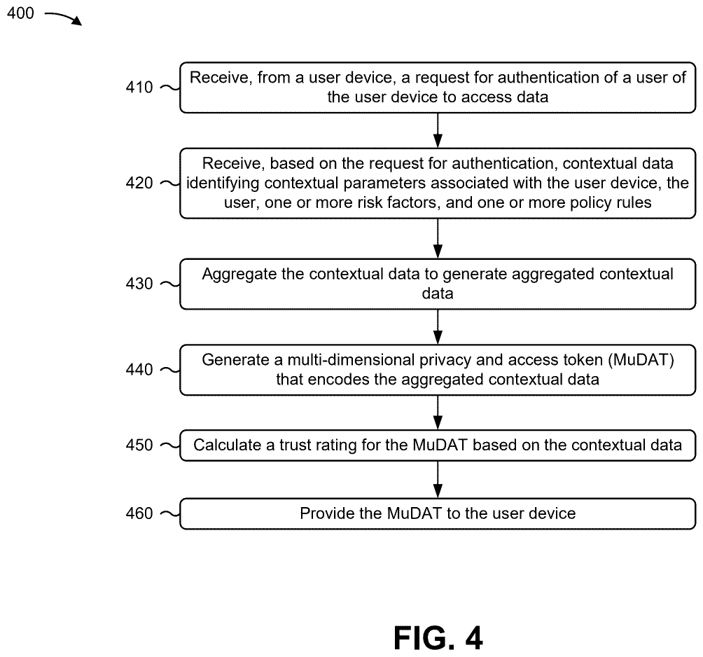

FIG. 4 depicts a flowchart of an example process 400 for authenticating data access using context-aware multi-dimensional privacy and access tokens. In some implementations, one or more process blocks of FIG. 4 may be performed by a device (e.g., the security system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a user device, a request for authentication of a user of the user device to access data (block 410). For example, the device may receive, from a user device, a request for authentication of a user of the user device to access data, as described above.

As further shown in FIG. 4, process 400 may include receiving, based on the request for authentication, contextual data identifying contextual parameters associated with the user device, the user, one or more risk factors, and one or more policy rules (block 420). For example, the device may receive, based on the request for authentication, contextual data identifying contextual parameters associated with the user device, the user, one or more risk factors, and one or more policy rules, as described above. In some implementations, the contextual parameters include parameters associated with one or more of a location of the user, a network condition of a network associated with the user device, or a subscription of the user. In some implementations, receiving the contextual data includes continually receiving the contextual data in real-time.

As further shown in FIG. 4, process 400 may include aggregating the contextual data to generate aggregated contextual data (block 430). For example, the device may aggregate the contextual data to generate aggregated contextual data, as described above.

As further shown in FIG. 4, process 400 may include generating a MuDAT that encodes the aggregated contextual data (block 440). For example, the device may generate a MuDAT that encodes the aggregated contextual data, as described above.

As further shown in FIG. 4, process 400 may include calculating a trust rating for the MuDAT based on the contextual data (block 450). For example, the device may calculate a trust rating for the MuDAT based on the contextual data, as described above.

As further shown in FIG. 4, process 400 may include providing the MuDAT to the user device (block 460). For example, the device may provide the MuDAT to the user device, as described above.

In some implementations, process 400 includes continually monitoring the contextual data, receiving modified contextual data based on monitoring the contextual data, and updating the MuDAT to generate an updated MuDAT based on the modified contextual data. In some implementations, process 400 includes calculating an updated trust rating for the updated MuDAT based on the modified contextual data, and providing the updated MuDAT to the user device.

In some implementations, process 400 includes receiving, from the user device, the MuDAT and a request to access data, and determining whether the MuDAT is valid based on the trust rating for the MuDAT. In some implementations, process 400 includes denying the request to access data based on determining that the MuDAT is invalid. In some implementations, process 400 includes retrieving data requested by the request to access data, partially masking the data to generate partially masked data based on determining that the MuDAT is invalid, and providing the partially masked data to the user device. In some implementations, process 400 includes retrieving data requested by the request to access data based on determining that the MuDAT is valid, and providing the data to the user device.

In some implementations, process 400 includes logging, in an audit log, data identifying one or more of generation, usage, updating, or revocation of the MuDAT. In some implementations, process 400 includes encrypting the MuDAT to generate an encrypted MuDAT. In some implementations, process 400 includes dynamically adjusting the trust rating based on changes in contextual data. In some implementations, process 400 includes receiving, from the user device, the MuDAT and a request to access data, comparing the trust rating for the MuDAT to a trust rating threshold, and selectively determining that the MuDAT is valid based on the trust rating for the MuDAT satisfying the trust rating threshold, or determining that the MuDAT is invalid based on the trust rating for the MuDAT failing to satisfy the trust rating threshold.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request for authentication of a user of a user device to access data;
receiving, by the device and based on the request for authentication, contextual data identifying contextual parameters associated with the user device, the user, one or more risk factors, and one or more policy rules;
aggregating, by the device, the contextual data to generate aggregated contextual data;
generating, by the device, a multi-dimensional privacy and access token (MuDAT) that encodes the aggregated contextual data;
calculating, by the device, a trust rating for the MuDAT based on the contextual data; and
providing, by the device, the MuDAT to the user device.

2. The method of claim 1, further comprising:
continually monitoring the contextual data;
receiving modified contextual data based on monitoring the contextual data; and
updating the MuDAT to generate an updated MuDAT based on the modified contextual data.

3. The method of claim 2, further comprising:
calculating an updated trust rating for the updated MuDAT based on the modified contextual data; and
providing the updated MuDAT to the user device.

4. The method of claim 1, further comprising:
receiving the MuDAT and a request to access data; and
determining whether the MuDAT is valid based on the trust rating for the MuDAT.

5. The method of claim 4, further comprising:
denying the request to access data based on determining that the MuDAT is invalid.

6. The method of claim 4, further comprising:
retrieving data requested by the request to access data;
partially masking the data to generate partially masked data based on determining that the MuDAT is invalid; and
providing the partially masked data to the user device.

7. The method of claim 4, further comprising:
retrieving data requested by the request to access data based on determining that the MuDAT is valid; and
providing the data to the user device.

8. A device, comprising:
one or more processors configured to:
receive a request for authentication of a user of a user device to access data;
receive, based on the request for authentication, contextual data identifying contextual parameters associated with the user device, the user, one or more risk factors, and one or more policy rules;
aggregate the contextual data to generate aggregated contextual data;
generate a multi-dimensional privacy and access token (MuDAT) that encodes the aggregated contextual data;
calculate a trust rating for the MuDAT based on the contextual data;
provide the MuDAT to the user device;
receive modified contextual data based on continually monitoring the contextual data;
and
update the MuDAT based on the modified contextual data.

9. The device of claim 8, wherein the one or more processors are further configured to:
log, in an audit log, data identifying one or more of generation, usage, updating, or revocation of the MuDAT.

10. The device of claim 8, wherein the one or more processors are further configured to:
encrypt the MuDAT to generate an encrypted MuDAT.

11. The device of claim 8, wherein the contextual parameters include parameters associated with one or more of a location of the user, a network condition of a network associated with the user device, or a subscription of the user.

12. The device of claim 8, wherein the one or more processors are further configured to:
dynamically adjust the trust rating based on changes in contextual data.

13. The device of claim 8, wherein the one or more processors, to receive the contextual data, are configured to:
continually receive the contextual data in real-time.

14. The device of claim 8, wherein the one or more processors are further configured to:
receive the MuDAT and a request to access data;
compare the trust rating for the MuDAT to a trust rating threshold; and
selectively:
determine that the MuDAT is valid based on the trust rating for the MuDAT satisfying the trust rating threshold, or
determine that the MuDAT is invalid based on the trust rating for the MuDAT failing to satisfy the trust rating threshold.

15. A non-transitory computer-readable medium storing a set of instructions, the set of instructions comprising:
one or more instructions that, when executed by one or more processors of a device, cause the device to:
receive a request for authentication of a user of a user device to access data;
receive, based on the request for authentication, contextual data identifying contextual parameters associated with the user device, the user, one or more risk factors, and one or more policy rules;
aggregate the contextual data to generate aggregated contextual data;
generate a multi-dimensional privacy and access token (MuDAT) that encodes the aggregated contextual data;
calculate a trust rating for the MuDAT based on the contextual data;
provide the MuDAT to the user device;
receive, from the user device, the MuDAT and a request to access data; and
determine whether the MuDAT is valid based on the trust rating for the MuDAT.

16. The non-transitory computer-readable medium of claim 15, wherein the one or more instructions further cause the device to:
continually monitor the contextual data;
receive modified contextual data based on monitoring the contextual data;
update the MuDAT to generate an updated MuDAT based on the modified contextual data; and provide the updated MuDAT to the user device.

17. The non-transitory computer-readable medium of claim 16, wherein the one or more instructions further cause the device to:
calculate an updated trust rating for the updated MuDAT based on the modified contextual data.

18. The non-transitory computer-readable medium of claim 15, wherein the one or more instructions further cause the device to:
deny the request to access data based on determining that the MuDAT is invalid.

19. The non-transitory computer-readable medium of claim 15, wherein the one or more instructions further cause the device to:
retrieve data requested by the request to access data;
partially mask the data to generate partially masked data based on determining that the MuDAT is invalid; and
provide the partially masked data to the user device.

20. The non-transitory computer-readable medium of claim 15, wherein the one or more instructions further cause the device to:
retrieve data requested by the request to access data based on determining that the MuDAT is valid; and
provide the data to the user device.
